(19) United States
(12) Patent Application Publication
(10) Pub. No.: US 2026/0016903 A1
(43) Pub. Date: Jan. 15, 2026

(54) Gesture-Driven CAPTCHA System for Touchless User Verification

(71) Applicant: Perdurable Group, Inc., Campbell, CA (US)

(72) Inventor: Oladayo Ayokunle Luke, Campbell, CA (US)

(73) Assignee: Perdurable Group, Inc., Campbell, CA (US)

(21) Appl. No.: 19/260,421

(22) Filed: Jul. 4, 2025

Related U.S. Application Data
(63) Continuation-in-part of application No. 19/040,873, filed on Jan. 30, 2025.
(60) Provisional application No. 63/664,187, filed on Jun. 26, 2024.

(51) Int. Cl. G06F 3/01; G06F 3/04812; G06F 3/0487; G06V 10/764; G06V 20/40; G06V 40/20

(52) U.S. Cl. CPC G06F 3/017; G06F 3/04812; G06F 3/0487; G06V 10/764; G06V 20/40; G06V 40/28

(57) ABSTRACT

A system and method are disclosed for touchless, gesture-based form validation using real-time input from a standard camera. Spatial hand gestures are interpreted as mouse-like actions—such as drag, click, scroll, and hold—to complete form tasks without physical input. The system includes a vision-based input module, an AI-powered gesture recognition engine using landmark extraction, an interaction handler that maps gestures to DOM-compliant events, and a validation controller that confirms field focus, checkbox toggling, and submission. A visual feedback renderer provides real-time cues indicating gesture success, failure, or activity. Navigation buttons enable directional control and element repositioning. The method supports secure CAPTCHA-style workflows via randomized tasks and gesture thresholds, executing natively in browsers using WebAssembly or TensorFlow.js. Applications include bot prevention, accessible interaction, and secure, device-free input for web and mobile environments.

### CROSS-REFERENCE TO RELATED APPLICATION

This application is a Continuation-in-Part (CIP) of U.S. Provisional Patent Application No. 63/664,187, filed on Jun. 26, 2024, entitled “Unified System for Gesture Recognition, Text Generation, and Audio Output”, which is hereby incorporated by reference in its entirety, as if set forth fully herein for all purposes.

### TECHNICAL FIELD

The present invention relates generally to human-computer interaction systems and, more specifically, to gesture-based authentication and form validation mechanisms. It also pertains to the fields of web security, cybersecurity, and user interface accessibility, particularly within web and mobile platforms using camera-based input and real-time gesture interpretation.

### BACKGROUND

As web-based platforms become increasingly interactive, the need for robust, accessible, and user-friendly human verification mechanisms has grown significantly. Traditional CAPTCHA systems, which require users to interpret distorted text or select specific images, often pose usability challenges-particularly for individuals with visual impairments, cognitive limitations, or motor skill issues. These systems are also increasingly vulnerable to automated bots using AI image recognition or click emulation technologies.

U.S. patent application Ser. No. 19/040,873, entitled “Unified System for Gesture Recognition, Text Generation, and Multi-Modal Communication,” discloses a comprehensive platform—also referred to as Inclusive GPT—that integrates gesture recognition with generative AI and multi-modal output strategies. The system focuses on advanced capabilities such as a three-stage gesture transformer architecture, real-time video generation, and federated learning for on-device privacy.

The zone-based navigation framework used in this invention is also covered in CIP application Ser. No. 19/260,063 titled Gesture Recognition and Command Execution Architecture for Touchless Interfaces.

The present invention builds on some of the foundational principles described in the above application, but differs in scope, architecture, and implementation. Specifically, it introduces gesture-based authentication and form validation mechanisms, and a real-time browser-native architecture optimized for direct integration into conventional digital interfaces. Unlike the prior art, which primarily focused on generalized gesture interpretation and multimodal communication, this invention emphasizes secure, localized gesture-based user verification, DOM-level interaction with form elements, and touchless CAPTCHA-style functionality using only a standard webcam and front-end browser technologies. It enables drag-and-drop, navigating draggle element using directional buttons, checkbox toggling, and pattern recognition tasks through in-air gestures-providing a novel, accessible, and bot-resistant method for verifying user identity and intent.

Touchless interfaces, powered by camera-based gesture recognition, offer a promising alternative for validating human presence and intent. However, existing solutions either rely on specialized hardware (e.g., depth sensors, motion cameras), are limited in complexity, or do not integrate seamlessly with HTML-based form elements.

There remains a need for a gesture-driven form validation system that operates using standard consumer-grade cameras, functions within mainstream browsers or mobile environments, and provides a more intuitive, secure, and accessible alternative to conventional CAPTCHA systems.

### PRIOR ART

### Carnegie Mellon CAPTCHA (2000)

CAPTCHA (Completely Automated Public Turing Test to Tell Computers and Humans Apart) invented by John Langford et al. Focused on image/text distortion challenges to validate humans. No gesture or camera-based interaction.

### US 2018/0052986 A1

Gesture-based CAPTCHA Test-Describes an image-based gesture CAPTCHA using standard or 3D image data. It requires users to perform one or more predetermined gestures for authentication.

### WO 2017/101071 A1

Facial Gesture CAPTCHA-Covers camera-based facial gesture prompts (e.g., wink, smile, head tilt) for CAPTCHA, designed to verify human presence using standard webcams.

### US 2023/0031200 A1

Touchless Gesture HMI-Describes gesture-driven device control; does not perform user verification or CAPTCHA-like validation.

### Behavioral & Sensor-Based CAPTCHA Research

Behavioral CAPTCHA using mobile sensor inputs (swipes, tilts) to differentiate bots. No camera/vision-based gesture tracking or form DOM control.

Nigerian proposal for gesture CAPTCHA tested at user-level input gestures.

In-air handwriting authentication-Utilizes finger movement patterns, but lacks CAPTCHA use, drag-and-drop gesture actions, or form validation use case.

### Unfulfilled Need

Despite advances in gesture recognition and web-based authentication, there remains no widely adopted solution that enables gesture-driven user verification directly within standard browser environments. Existing CAPTCHA systems rely heavily on static image-based puzzles or audio challenges, which are both exclusionary to certain user groups and increasingly vulnerable to automation. Similarly, prior gesture-based systems often require proprietary hardware, specialized environments, or lack compatibility with form elements in dynamic web and mobile applications.

There is a critical need for a touchless, camera-based form validation method that offers both accessibility and security, while being deployable across existing platforms without backend overhauls or external device dependencies. A solution that integrates gesture-based navigation using direction buttons, along with real-time drag-and-drop, checkbox toggling, and confirmation actions, enables seamless interaction without the need for typing, clicking, or touchscreen input. This approach addresses a significant gap in inclusive and secure human-computer interaction by offering a fully touchless interface that enhances accessibility and usability for diverse user groups.

### Failures of Others

Existing CAPTCHA systems and gesture-based verification methods have consistently fallen short in addressing the dual challenges of accessibility and bot resistance. Traditional CAPTCHA approaches rely on distorted text, image selection, or audio-based puzzles, which are not only difficult for users with disabilities but are also increasingly solvable by machine learning algorithms and automated bots. These methods often frustrate legitimate users, leading to abandonment and degraded user experience

Prior gesture-based systems have generally required specialized hardware (e.g., depth cameras, infrared sensors), been limited to narrow use cases such as gaming or device control or lacked the ability to interact meaningfully with HTML form elements in a web environment. Few, if any, solutions have offered a real-time, browser-native interface that enables form authentication actions via camera-tracked hand gestures, such as dragging objects to targets or toggling checkboxes.

Moreover, gesture-based authentication systems currently on record do not provide a gesture-optimized form of interaction logic, such as support for configurable gesture patterns, validation thresholds, or adaptive visual feedback that ensures both usability and security in human verification contexts. These limitations leave a critical void in user-friendly, inclusive, and secure digital interaction design-especially as the demand for hands-free technologies and remote authentication continues to grow.

Problems with Prior Art

### CAPTCHA (2000, Carnegie Mellon)

Visual and audio CAPTCHA are difficult for disabled users and now solvable by bots. Lacks gesture input, contextual flexibility, or modern real-time interaction models required for touchless validation.

### US 2018/0052986 A1—Gesture-based CAPTCHA Test

Failure: Requires users to replicate predefined gestures, limiting flexibility. It lacks integration with real-time HTML form components and does not support gesture zoning or drag-and-drop interaction within browser DOM elements. The system is not optimized for dynamic, modular validation workflows across web/mobile platforms.

### WO 2017/101071 A1—Facial Gesture CAPTCHA

Failure: Focuses solely on facial expressions (e.g., wink, head tilt) and excludes hand gestures or object manipulation. It does not address direct form validation, gesture zoning, or CAPTCHA versatility using hand-based camera input.

### US 2023/0031200 A1—Touchless Gesture HMI

Failure: Designed for gesture-driven device control but not intended for authentication or CAPTCHA-style verification. It does not validate user presence or distinguish between human users and bots in form workflows.

### Behavioral & Sensor-Based CAPTCHA Research

Failure: Uses device sensors like accelerometers to infer behavior. Lacks any vision-based input, camera-driven gesture analysis, or DOM-based interaction. Not applicable to desktop environments or hands-free gesture systems.

### Nigerian Proposal—In-air Handwriting Authentication

Failure: Focused on biometric authentication using unique motion patterns. It does not implement CAPTCHA, nor does it perform DOM-level form control such as checkbox verification or drag-to-target gestures.

### Serious Nature of the Problem

As digital systems increasingly rely on automated verification to differentiate human users from bots, existing CAPTCHA and authentication mechanisms are facing escalating challenges in security, accessibility, and usability. Modern robots (or web crawlers) now utilize AI and machine learning to bypass conventional CAPTCHAs, rendering many legacy systems ineffective at safeguarding user authentication and form integrity.

Simultaneously, these verification tools have become a point of friction for legitimate users particularly those with visual, cognitive, or motor impairments-who find them difficult or impossible to complete. The one-size-fits-all model of current CAPTCHA systems has resulted in poor user experience, increased form abandonment rates, and legal scrutiny under accessibility mandates such as WCAG and ADA.

Moreover, the lack of real-time, touchless, and camera-native solutions limits the adoption of secure verification tools in environments where traditional input methods are impractical or impossible. With the rise of remote access, kiosk interfaces, hands-free computing, and inclusive design standards, the need for a more intelligent, adaptive, and accessible form of user validation has become urgent and unavoidable.

### SUMMARY OF THE INVENTION

The present invention provides a novel system and method for validating human presence and intent using a touchless, gesture-driven mechanism integrated directly into web, mobile, and embedded digital interfaces. Unlike traditional CAPTCHA and authentication systems that rely on visual puzzles, audio cues, or sensor gestures, this invention leverages a consumer-grade camera to capture and analyze hand gestures in real time.

At its core, the system implements a gesture-based validation layer that replaces conventional verification inputs with purposeful actions such as dragging a visual object into a designated zone, performing directional swipes to confirm selection, or gesturing to simulate a mouse click or form checkbox validation. These actions are recognized using lightweight vision models and mapped to interactive DOM elements, allowing seamless compatibility with standard HTML forms and dynamic content.

The invention further introduces a gesture zoning framework that segments the interaction surface into predefined regions, each assigned specific gesture meanings or command types. This zoning supports navigation across moving elements, shapes, images, or UI components using gesture-based controls, enabling precise interaction. The framework allows the system to distinguish between intentional validation gestures and incidental movement, thereby ensuring accuracy and minimizing false positives.

Optimized for browser-native execution, the architecture supports low-latency performance using technologies such as WebAssembly and TensorFlow Lite. All gesture interpretation and interaction logic is processed on the client side, preserving user privacy and enabling full compliance with accessibility and data security standards.

Applications of the invention include form security, inclusive authentication workflows, and verification protocols across public kiosks, assistive interfaces, and resource-constrained environments. The system introduces a new paradigm of hands-free, gesture-based form validation that is secure, accessible, and adaptive to modern human-computer interaction demands.

### Functional Benefits:

The disclosed invention delivers multiple functional benefits that enhance usability, accessibility, and security in form validation and user verification workflows. Key advantages include:

Touchless Verification: Enables users to perform validation tasks (e.g., confirming form submissions, proving human presence) without physical contact-ideal for accessibility scenarios, public kiosks, or sterile environments.

Real-Time Gesture Recognition: Processes camera input dynamically to recognize hand gestures and map them to interactive elements (e.g., checkboxes, sliders, draggable objects), reducing latency and improving user feedback.

Browser-Native Compatibility: Operates entirely within modern browsers without requiring external plugins or hardware. Supports DOM-level integration for interactive HTML form elements, improving deployment efficiency.

User-Centric Security: Introduces behavioral verification via deliberate gesture patterns rather than simple clicks, making it more resistant to automation, AI bots, and replay attacks than traditional CAPTCHA systems.

Platform Deployment: Designed to work uniformly across web, mobile, tablet, and touchscreen platforms using standard front-facing cameras, enhancing deployment reach and UX consistency.

Privacy-First Architecture: All gesture interpretation is conducted locally on the device-no video or biometric data is transmitted, stored, or shared-ensuring high compliance with privacy regulations.

Accessibility Integration: Replaces visual CAPTCHA elements with spatial gestures, supporting screenless input scenarios and enhancing usability for visually impaired or motor-limited users.

### Key Innovative Aspects

The invention introduces several groundbreaking innovations that distinguish it from existing CAPTCHA, gesture, and authentication systems:

Gesture-Based Form Validation at DOM-Level: Directly integrates with standard HTML form elements, allowing users to perform gesture-driven interactions such as ticking checkboxes, dragging and dropping objects, or simulating mouse clicks-all captured through camera input.

Multi-Zonal Gesture Recognition Framework: Implements a spatial zoning model to distinguish between action-intent gestures (e.g., verification, submission) and ambient hand movement, improving classification accuracy and UX design.

Touchless CAPTCHA Alternative: Reinvents the CAPTCHA paradigm by replacing textual or image puzzles with intuitive, low-effort hand gestures. It maintains security while enhancing accessibility and reducing user frustration.

Privacy-Preserving Architecture: Performs all processing client-side with no video or biometric data storage or transmission, ensuring user privacy and simplifying regulatory compliance.

Inclusive and Accessible by Design: Designed to support users with disabilities by removing reliance on mouse, keyboard, or screen-based cognitive load. Can be combined with screen readers or voice assistants.

Security through Behavior-Based Verification: Relies on deliberate gesture input sequences, making it significantly more resistant to AI bots, automated scripts, and spoofing techniques compared to traditional CAPTCHAs.

### BRIEF DESCRIPTION OF THE FIGURES

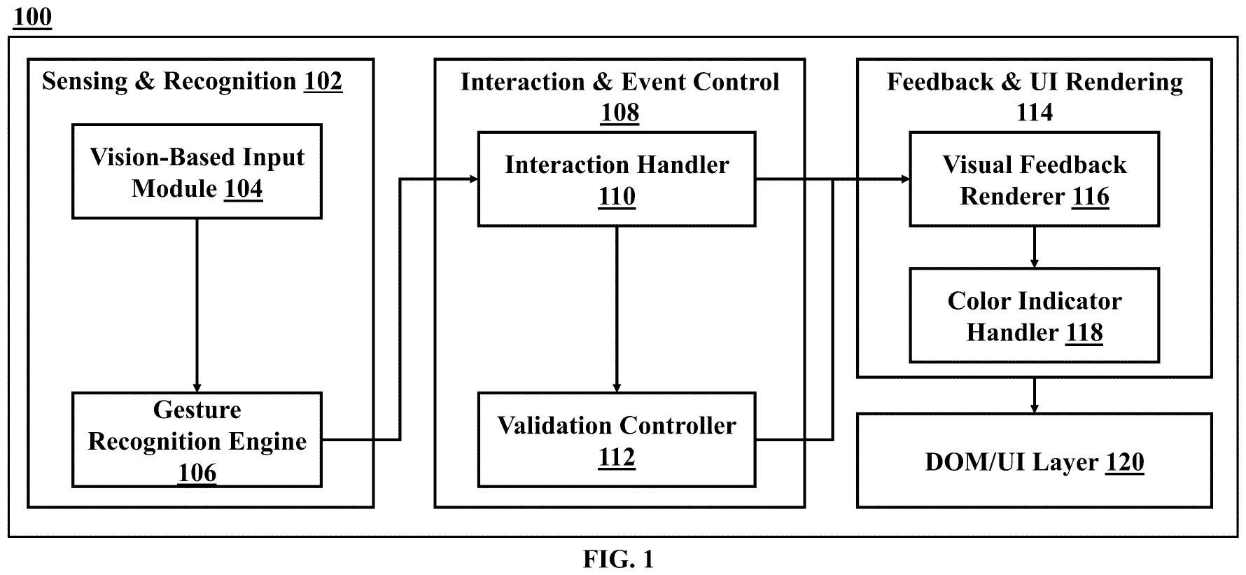

Referring to FIG. 1, the System Architecture (100) illustrates touchless gesture-based form validation using consumer-grade video input devices. The system comprises functional groups organized into sensing, recognition, interaction control, and feedback rendering layers. Core components include the Vision-Based Input Module (104), Gesture Recognition Engine (106), Interaction Handler (110), Validation Controller (112), Visual Feedback Renderer (116), and associated rendering and event dispatch elements.

### Detailed Description of Figures

FIG. 1 illustrates a system architecture for touchless gesture-based form validation, divided into three functional groups: Sensing & Recognition (101), Interaction & Event Control (108), and Feedback & UI Rendering (114).

The system begins with the Vision-Based Input Module (104), which captures live video feed from a consumer-grade camera. This module processes the incoming video by converting it into individual frames, adjusting resolution, filtering backgrounds, and isolating regions of interest (ROI) to improve gesture detection accuracy. The processed data is forwarded to the Gesture Recognition Engine (106).

The Gesture Recognition Engine (106) integrates two core subcomponents: a landmark extractor and a gesture classification model based on artificial intelligence. The landmark extractor identifies key hand landmarks—such as fingertips and joints—in each frame. These coordinates are passed to the AI model, which could be implemented using CNNs or frameworks like TensorFlow.js or ONNX, to classify the gesture type (e.g., drag, click, hold, or scroll). The engine also computes motion vectors and timing metrics to support high-precision real-time gesture classification.

Gesture classifications are passed to the Interaction Handler (110), which translates gesture types into mouse events emulated in the Document Object Model (DOM). These events include mousedown, mousemove, mouseup, click, and custom pointer operations. The Interaction Handler enables users to perform drag-and-drop actions, checkbox selections, and other pointer-based tasks without physical contact. Navigation buttons may also be used to reposition elements by simulating directional movement or direct placement. The Interaction Handler identifies target elements via bounding box overlap or DOM selectors and forwards interaction outcomes to the Validation Controller (112).

The Validation Controller (112) ensures that gesture-induced actions align with valid form interactions. It verifies whether dragged objects are correctly positioned within designated drop zones and checks form fields or virtual checkboxes for valid toggles. This module also tracks the number of user attempts; after repeated unsuccessful tries, it escalates gesture complexity or triggers new randomized tasks. This validation logic ensures the security and reliability of gesture-based input while protecting against spoofing or automation.

Feedback from validated interactions is rendered by the Visual Feedback Renderer (116). This component offers real-time visual cues through DOM overlays, color-coded indicators, and CSS updates. The renderer leverages the Color Indicator Handler (118) to modify the color of the pointer and target objects based on interaction status: blue indicates an active drag, green confirms a successful action or drop, and red signifies a failed gesture. These indicators enhance user comprehension and system transparency.

Finally, the DOM/UI Layer (120) serves as the rendering destination for all interface updates and interactive feedback. It reflects state changes initiated by gesture recognition and validation modules, such as updated form field states, highlighted elements, or animations corresponding to pointer gestures.

This architecture supports robust, real-time touchless form interaction and validation directly within a web browser, leveraging lightweight AI models and native browser integration to achieve responsive and secure gesture-based input.

### DETAILED DESCRIPTION OF THE INVENTION

The present invention discloses a system and method for form validation and user verification through real-time, touchless hand gesture recognition using consumer-grade cameras. The system replaces conventional CAPTCHA mechanisms with gesture-based inputs, allowing users to validate form submissions or confirm human presence by performing intuitive hand motions interpreted directly in the browser.

System Architecture: The invention comprises several interlinked modules:

Vision-Based Input Module: Captures real-time video from a front-facing webcam and preprocesses frames for hand detection using browser-based machine learning models. It supports dynamic resolution scaling and input throttling to balance performance and resource use.

The Gesture Recognition Engine comprises a real-time visual processing module that utilizes lightweight landmark recognition models in combination with convolutional neural networks (CNNs) or equivalent AI/ML architectures such as TensorFlow.js or ONNX runtime. This engine is configured to analyze frame sequences captured from the vision-based input module, extract key hand and finger landmarks, and infer gestural intent based on spatial patterns and temporal motion vectors.

Specifically, the engine classifies recognized gestures into discrete interaction types including, but not limited to:

Drags: Continuous hand movement tracked across screen coordinates with positional inertia.

Mouse Events: Emulated input actions such as mouse-down, mouse-release, scroll (vertical/horizontal), and hover.

Clicks: Tapping or pinch-like gestures interpreted as mouse clicks or DOM element selection.

Holds: Sustained static poses or gestures used to activate contextual overlays or selection states.

Output from the engine is passed to the Interaction Handler, which maps gestures to DOM-level input operations or visual feedback elements. The engine operates entirely on the client side to ensure privacy, low-latency, and device-native performance.

Interaction Handler: Interaction Handler: Maps recognized gestures to interactive form components (e.g., HTML checkboxes, submit buttons, draggable elements). For example, a downward swipe gesture may simulate a checkbox selection, a grab-and-release gesture may trigger a drag-and-drop action, and directional gestures or navigation buttons may reposition elements or traverse through focusable form fields. Specifically, gestures such as RIGHTDOWN or LEFTDOWN may indicate lateral movements (e.g., moving right or left), while gestures like RIGHT or LEFT may signal vertical navigation (e.g., moving up or down). This handler enables real-time, contactless interaction with standard web elements, supporting accessible and inclusive user experiences.

Validation Controller: The Validation Controller monitors real-time DOM activity and verifies that gesture-induced interactions align with valid form behaviors. It cross-references each gesture-triggered action (e.g., checkbox selection, object drag-drop) against a set of validation rules defined by the application context. This module is responsible for ensuring compliance with form submission requirements, safeguarding against accidental submissions, automation spoofing, or gesture misclassifications.

In drag-and-drop tasks, the Validation Controller confirms that the object is accurately positioned within an allowable drop zone. It also tracks the number of user attempts to complete such actions. If a user exceeds a predefined attempt threshold, the system automatically increases task complexity or issues a randomized new validation prompt, thereby enhancing security and resilience against automation or brute-force emulation.

The Visual Feedback Renderer module provides real-time, intuitive visual cues to guide the user through gesture-based interactions and to confirm system recognition of valid actions. This module enhances user trust and accessibility by eliminating ambiguity during gesture execution.

A custom cursor or pointer element, rendered as a circular overlay, dynamically follows the detected hand or finger position. The pointer's color and outline change to reflect the currently recognized gesture or mouse event state:

Idle: Default color (e.g., blue) indicates system readiness.

Mouse-Down/Gesture Initiated: Pointer changes to a highlighted color (e.g., yellow) indicating engagement.

Drag in Progress: Pointer color transitions (e.g., to orange) and may pulse to show active movement.

Valid Drop Position Detected: Target object or pointer turns green, indicating a valid gesture and drop alignment.

Invalid Gesture or Position: Visual elements change to red or another alert color to signal gesture rejection or incorrect target alignment.

This feedback loop enables users to receive constant non-verbal confirmation of gesture intent, progress, and outcome. The Renderer module ensures smooth visual transitions using CSS animations or canvas rendering for performance-optimized responsiveness.

### CONCLUSION

The present invention introduces a novel and robust method for form validation that leverages real-time, touchless gesture recognition using standard camera input and browser-native execution. By combining a vision-based input module, an AI-driven gesture recognition engine, emulated mouse interactions, and DOM-integrated validation logic, the system enables seamless drag-and-drop or tap-style gesture interactions for verifying human input.

This approach surpasses traditional CAPTCHA mechanisms by offering an intuitive, accessible, and secure validation method without requiring external plugins, proprietary hardware, or keyboard interaction. The layered architecture with real-time visual feedback and adaptive validation complexity ensures a scalable and user-friendly solution suited for modern web and mobile platforms.

The invention is particularly advantageous for accessibility applications, bot prevention, and immersive user interfaces where touchless interaction is preferred or required. It sets the stage for the future of secure, multimodal human-computer interaction while enabling compliant, privacy-conscious deployment in diverse environments.

1. A system for touchless, camera-mediated form validation on a digital user interface, comprising:
a vision-based input capture module configured to capture hand gestures via a standard camera;
a gesture recognition model configured to extract hand landmarks from video input and apply mathematical computations to classify gesture types;
a mouse event emitter module configured to simulate pointer actions including drag, drop, and clicks based on gesture classification;
a DOM integration layer configured to identify and interact with web or mobile user interface elements using simulated events, including navigation of focusable elements and repositioning of draggable components via directional gestures or virtual navigation buttons;
a form validation engine configured to confirm form field interactions triggered by gestures; and
a feedback module configured to provide real-time visual cues to indicate success or failure of gesture-based validation.

2. The system of claim 1, wherein the gesture recognition model uses browser compatible inference frameworks such as TensorFlow.js or ONNX.

3. The system of claim 1, wherein the mouse event emitter changes visual pointer indicators based on active gesture type, such as drag, hover, or release.

4. The system of claim 1, wherein the DOM integration layer operates entirely within a browser environment using native web APIs or WebAssembly.

5. The system of claim 1, wherein the feedback module visually distinguishes successful and unsuccessful form actions by changing pointer or object colors dynamically.

6. A method of touchless form validation using gesture-based mouse emulation, comprising:
capturing real-time hand movements using a standard camera;
detecting hand landmarks and classifying gestures via a trained model;
simulating mouse actions such as click, drag, or drop using gesture-based inputs and virtual navigation buttons;
interacting with user interface elements via DOM event emissions;
validating form interactions based on predefined success criteria; and
providing visual feedback to confirm completion or error in gesture execution.
